(19) United States
(12) Patent Application Publication
(10) Pub. No.: US 2021/0061159 A1
(43) Pub. Date: Mar. 4, 2021

(54) CAMERA-ASSISTED USE OF TOWED EQUIPMENT

(71) Applicant: TOYOTA MOTOR NORTH AMERICA, INC., PLANO, TX (US)

(72) Inventor: SAI PRITHVI GADDE, Addison, TX (US)

(21) Appl. No.: 16/552,717

(22) Filed: Aug. 27, 2019

(51) Int. Cl. B60P 7/06; B60Q 9/00; H04N 5/225; G06T 7/00; G06T 7/20; G06T 7/70

(52) U.S. Cl. CPC B60P 7/06; B60Q 9/00; H04N 5/2253; B60R 11/04; G06T 7/20; G06T 7/70; G06T 7/0002

(57) ABSTRACT

Systems and methods are provided for automatically adjusting a vehicle payload, comprising: an image sensor mounted to capture images of a vehicle payload; a cargo monitoring circuit coupled to receive captured images of the vehicle payload from the image sensor and configured to process the received captured images to detect a payload characteristic; a processing device configured to determine a payload status based on the payload characteristic and to generate a correction signal if the determined payload status indicates the payload is out of specification; and an actuator coupled to receive the correction signal from the processing device, the actuator configured to perform an action to adjust a payload characteristic in response to the correction signal.

### TECHNICAL FIELD

The present disclosure relates generally to payload monitoring, and in particular, some implementations may relate to using image sensors to monitor cargo status for a vehicle or trailer cargo.

### DESCRIPTION OF RELATED ART

Trailers and other vehicles with cargo capacity have been used extensively for hauling payloads and other cargo of many types. Unfortunately, conditions of the cargo can change, sometimes causing dangerous situations. Cameras have been used in some circumstances to monitor the status of cargo but offer limited capabilities beyond the monitoring and reporting of cargo status.

Image information has been used to generate data such as filling grade, distribution of the load within the load space, counting load quantity, or other load measurements. Load information determined from the images can be compared to reference data to determine whether the payload is within specification (e.g., maximum load, load distribution, etc).

### BRIEF SUMMARY OF THE DISCLOSURE

According to various embodiments of the disclosed technology a system for automatically adjusting a vehicle payload may include: an image sensor mounted to capture images of a vehicle payload; a cargo monitoring circuit coupled to receive captured images of the vehicle payload from the image sensor and configured to process the received captured images to detect a payload characteristic; a processing device configured to determine a payload status based on the payload characteristic and to generate a correction signal if the determined payload status indicates the payload is out of specification; and an actuator coupled to receive the correction signal from the processing device, the actuator configured to perform an action to adjust a payload characteristic in response to the correction signal.

The system may further include a motion sensor mounted to collect data regarding movement of the payload and the processor may be further configured to evaluate the data collected from the motion sensor to determine whether an amount of movement of the payload is above a determined threshold.

The actuator may include a cargo restraint device, and in some embodiments, the action to adjust a payload characteristic performed by the actuator includes adjusting the restraint device to tighten a restraint on the payload. In some embodiments, the actuator comprises a water valve coupled to a nozzle and In some embodiments, the action to adjust a payload characteristic performed by the actuator comprises opening the water valve for a determined period of time to apply moisture to the payload.

The processing device may further be configured to determine which corrective action to implement to adjust the payload characteristic and to generate an alert indicating that the payload is out of specification. The processing device may also be configured to determine a payload status based on the payload characteristic comprises a processing device located onboard the vehicle or remote to the vehicle.

A method for automatically adjusting a vehicle payload may include: capturing images of a vehicle payload using an image sensor; receiving the captured images of the vehicle payload from the image sensor and processing the received captured images to detect a payload characteristic; determining a payload status based on the payload characteristic and generating a correction signal if the determined payload status indicates the payload is out of specification; and transmitting the correction signal to an actuator configured to perform an action to adjust a payload characteristic in response to the correction signal.

The method may further include collecting motion data regarding movement of the payload and evaluating the collected motion data to determine whether an amount of movement of the payload is above a determined threshold.

In some embodiments, the actuator includes a cargo restraint device and the action to adjust a payload characteristic performed by the actuator may include adjusting the restraint device to tighten a restraint on the payload.

In some embodiments, the actuator includes a water valve coupled to a nozzle and In some embodiments, the action to adjust a payload characteristic performed by the actuator comprises opening the water valve for a determined period of time to apply moisture to the payload.

In some embodiments, the method may further include determining which corrective action to implement to adjust the payload characteristic. The method may further include generating an alert to an operator of the vehicle indicating that the payload is out of specification.

In some embodiments, the operation of determining a payload status based on the payload characteristic is performed onboard the vehicle or remote to the vehicle.

A vehicle payload system for automatically adjusting a vehicle payload may include: a processor; and a memory coupled to the processor to store instructions, which when executed by the processor, cause the processor to perform operations, the operations comprising: receiving captured images of a vehicle payload from an image sensor mounted on the vehicle and processing the received captured images to detect a payload characteristic; determining a payload status based on the payload characteristic and generating a correction signal if the determined payload status indicates the payload is out of specification; and transmitting the correction signal to an actuator configured to perform an action to adjust a payload characteristic in response to the correction signal.

The payload system may further include collecting motion data regarding movement of the payload and evaluating the collected motion data to determine whether an amount of movement of the payload is above a determined threshold.

In some embodiments, the actuator includes a cargo restraint device and the action to adjust a payload characteristic performed by the actuator may include adjusting the restraint device to tighten a restraint on the payload.

In some embodiments, the actuator includes a water valve coupled to a nozzle and In some embodiments, the action to adjust a payload characteristic performed by the actuator comprises opening the water valve for a determined period of time to apply moisture to the payload.

In some embodiments, the method may further include determining which corrective action to implement to adjust the payload characteristic. The method may further include generating an alert to an operator of the vehicle indicating that the payload is out of specification.

In some embodiments, the operation of determining a payload status based on the payload characteristic is performed onboard the vehicle or remote to the vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example process for cargo monitoring and correction in accordance with one embodiment of the systems and methods described herein.

FIG. 3 illustrates an example of a vehicle equipped with a camera to monitor payload status.

FIG. 4 illustrates an example architecture for cargo monitoring and correction in accordance with one embodiment of the systems and methods described herein.

FIG. 5 illustrates an example process for cargo monitoring and correction in accordance with one embodiment of the systems and methods described herein.

FIG. 6 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can be configured using a rear backup camera or other camera(s) of the vehicle to capture images of a payload being carried in a cargo bed of the vehicle or by a trailer attached to the vehicle. Image processing can be used to determine whether special attention is needed by the payload. This allows a more automated and real-time approach to addressing payload issues.

Cameras (e.g., image sensors) can be used to detect images of the payload and image processing techniques can be used to monitor the condition. Certain conditions may be flagged as conditions requiring attention in which case, the system can address the needs. The system may also be configured to alert the driver or a payload owner of the issue so that the driver can take action to address the issue.

For example, the system may detect that crops or produce being hauled in the trailer are drying out and may determine an action is needed to provide necessary moisture. In this case, an auxiliary system, such as a misting system, can be activated to mist the crops. The system can determine the volume of water that might be useful to address the crop issue in the period of time over which to apply moisture to the payload. The system may also be configured to adjust a previously determined watering schedule based on payload characteristics determined by the system. The system may also consider An example misting system might include, for example, one or more water valves coupled to one or more spray nozzles with appropriate actuators to open and close the valves and actuators to adjust the strength or pattern of the spray nozzles. As another example, the image processing system may determine that the payload is loose and needs to be better secured. The system may be configured to actuate electrically controlled winches to tighten the payload. Alternatively, the system may alert the vehicle operator so that the operator can stop the vehicle and adjust the payload accordingly.

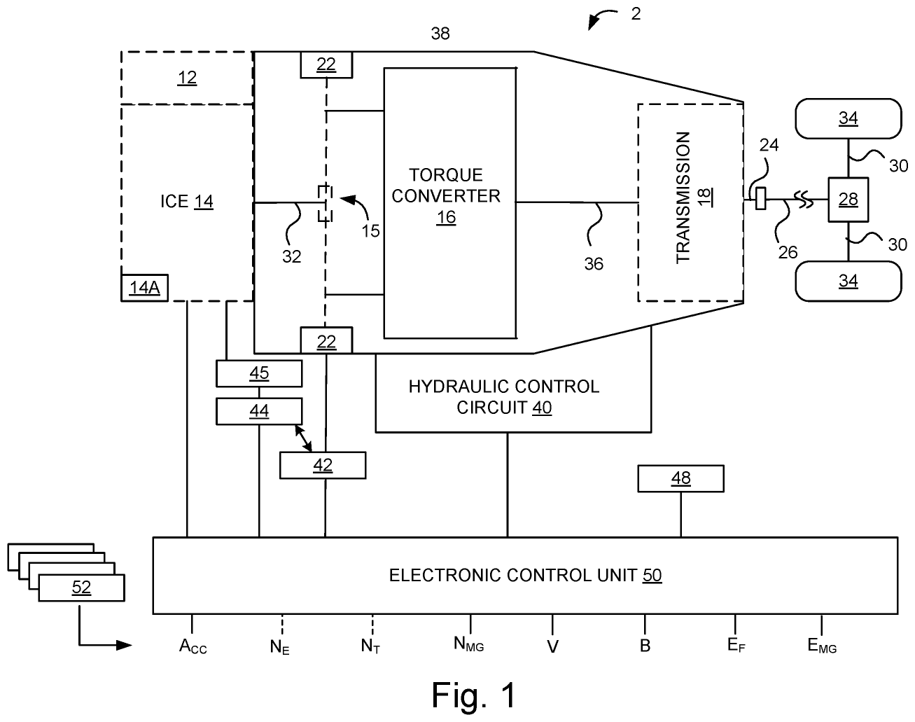

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for cargo monitoring and management can be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

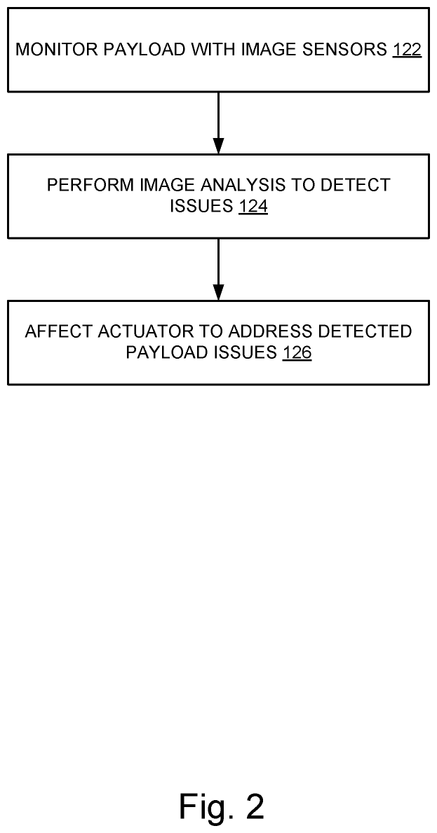

FIG. 2 illustrates an example architecture for payload management and monitoring in accordance with one embodiment of the systems and methods described herein. Referring now to FIG. 2, in this example at operation 122, the system uses one or more image sensors mounted such that they have a view of the cargo area to monitor the payload being carried by the vehicle (e.g., within the vehicle itself or a trailer). Different quantities of cameras can be used with different viewing angles (fields of view) to capture appropriate views of the payload depending on the payload type and volume. Fields of view of the cameras can be considered along with their mounting positions to ensure that appropriate coverage of the payload or the cargo area is provided as may be appropriate for the situation. Cameras can also be provided with pan, tilt and zoom capabilities (e.g., optical or electromechanical pan, tilt, zoom) to enable the camera to be positioned or zoomed in real-time to capture images appropriate for monitoring the payload and detecting anomalies.

At operation 124, the received images are processed by an image processing system to analyze the payload and determine whether the payload is nominal or whether it is out of specification such that it needs to be corrected. Any of a number of different processing techniques can be used depending on the type of cargo and the situations for which monitoring is appropriate. For example, correct cargo position can be captured when the cargo is initially secured in the vehicle. Payload position and images captured subsequent to this initial image can be compared with the initial image to see if the payload has shifted during transit.

As another example, motion of the payload can be studied in a series of frames (e.g., in frames of a captured video, or in multiple still frames) to determine whether motion of the payload is out of specification. This might indicate, for example, that the payload is insufficiently secured in the cargo area. Radar, lidar, infrared, RFID or other like motion sensors might additionally be used to determine a location of and monitor movement of the payload in the cargo area. For example, the cameras or these other sensors can capture images, motion data, position data (which can be used to determine motion data) or other data that can be analyzed to detect whether the payload shifts during acceleration, cornering or braking, or whether the payload is bouncing up and down excessively. These conditions might indicate that the payload is too lose.

At operation 126, if there is an issue with the payload that requires correction as determined by the image analysis, the system can be configured to implement that correction. For example, if the payload is shifting or bouncing excessively during transit, electronic winches or other fasting devices can be remotely actuated by the system to tighten the restraints that are restraining the load to thereby reduce the amount of movement during Transit. As another example, if the cameras or other sensors indicate that the payload is drying excessively (e.g., fresh produce is drying more than expected), water nozzles can be actuated to spray the payload with a determined amount of moisture to preserve the payload.

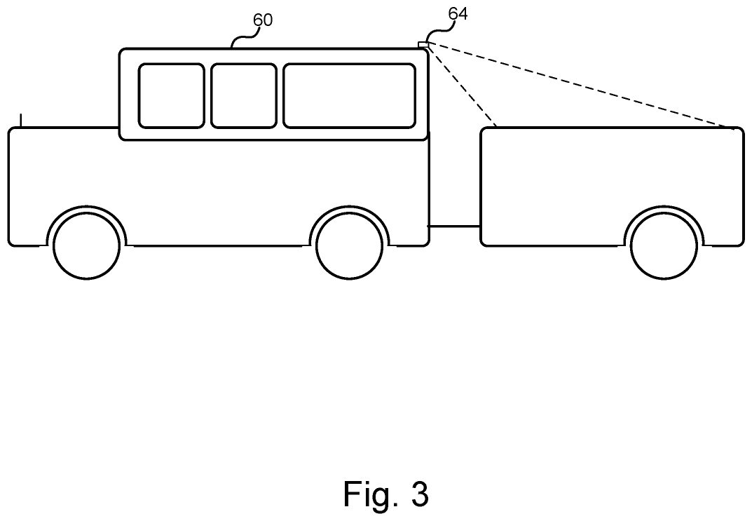

FIG. 3 illustrates an example of a vehicle configured with a camera to monitor cargo status in accordance with one embodiment. In this example, camera 64 is mounted on the upper rear of vehicle 60 to monitor the cargo carried in the trailer of vehicle 60. Camera 64 may include a housing to house an image sensor such as a CMOS or other semiconductor image sensor to capture images of a scene. A lens may be included to focus the scene onto the image sensor for image capture. The focal length of the lens can be chosen to capture the appropriate cargo area depending on the size of the cargo area and the number of cameras used. The lens can include a fixed or variable focal length and it can include a fixed or variable aperture. Although not shown, an adjustable electromechanical mount can be included on which the camera can be mounted to allow adjustment of features such as pan and tilt angles for the camera. In other embodiments fixed or manually adjustable mounts can be provided for the camera.

The image sensor can be read by reading the pixel information and the resultant electronic image information provided for image processing. Image processing can take place on board vehicle 60 such as at camera 64, within a vehicle head unit or within another image processing system contained within vehicle 60. In other applications, image processing can take place external to the vehicle such as on a cloud server or other remote server, or with Edge processing. Accordingly, a wireless communications interface can be included to transfer the images for images of analysis external to the vehicle.

Although only one camera 64 is Illustrated in the example of FIG. 3, embodiments can be implemented with other quantities of cameras, depending on the shape and size of the cargo area to be monitored. In some instances, cameras may be dedicated to payload monitoring or the camera functions can be shared with other vehicles function such as, for example, reversing and parking functions, Lane change assist, trailer support, surround Vision assist and other vehicle functions.

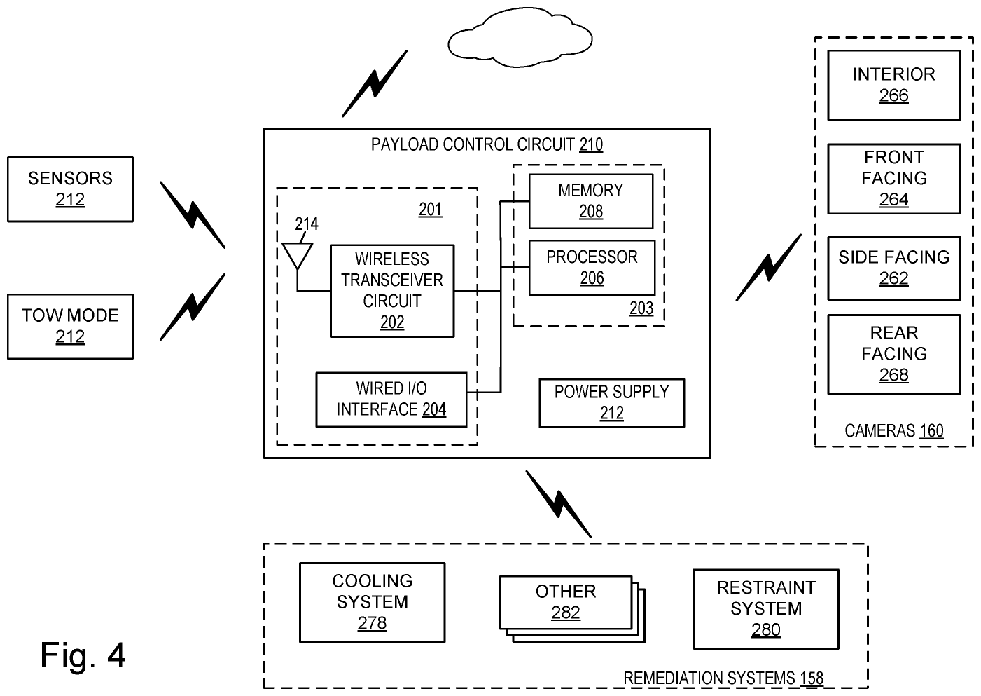

FIG. 4 illustrates an example architecture for payload monitoring and management in accordance with one embodiment of the systems and methods described herein. Referring now to FIG. 4, in this example, payload monitoring system 200 includes a payload control circuit 210, one or more sensors 214, one or more remediation systems 158, one or more cameras 160 and a tow mode circuit 216. Sensors 214, remediation systems 158, one or more cameras 160 and a tow mode circuit 216 can communicate with payload control circuit 210 via a wired or wireless communication interface.

In this example, cameras 160 include a backup or other rear-facing camera 268, an interior payload camera 266, a side-facing camera 262 and a front-facing camera 264. As this example illustrates, a backup camera 268 such as that used to facilitate parking and other vehicle reversing operations can serve a dual purpose and provide monitoring of cargo in a cargo area as well as support parking functions. Where the vehicle includes interior cargo spaces, one or more interior payload cameras 266 can be provided to capture images of the payload within the payload compartment. A rear-facing camera or cameras 268 may also be included (e.g., such as camera 64) to capture payload in a trailer or otherwise mounted aft of the vehicle. In other embodiments, other cameras or quantities of cameras may be included depending on the position, location, volume and shape of the payload.

Although sensors 214, remediation systems 158, cameras 160, tow mode circuit 216 and remediation systems 158 are depicted as communicating with payload control circuit 210, they can also communicate with each other as well as with other vehicle systems. Communication circuit 201 can be used to transmit and receive information among these various components. Also, these components may communicate directly or indirectly with one another. Payload control circuit 210 can be implemented as an ECU or as part of an ECU such as, for example electronic control unit 50. In other embodiments, payload control circuit 210 can be implemented independently of the ECU.

Payload control circuit 210 in this example includes a communication circuit 201, a decision circuit 203 (including a processor 206 and memory 208 in this example) and a power supply 212. Components of payload control circuit 210 are illustrated as communicating with each other via a data bus, although other communication in interfaces can be included. Payload control circuit 210 may also include a manual assist switch (not shown) that can be operated by the user to manually select/disable the control mode.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to payload control circuit 210.

Although the example of FIG. 4 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a payload control circuit 210.

Communication circuit 201 either or both a wireless transceiver circuit 202 with an associated antenna 214 and a wired I/O interface 204 with an associated hardwired data port (not illustrated). As this example illustrates, communications with payload control circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, V2V, V2I and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by payload control circuit 210 to/from other entities such as sensors 214 and remediation systems 158.

Wired I/O interface 204 can include a transmitter and a receiver (not shown) for hardwired communications with other devices. For example, wired I/O interface 204 can provide a hardwired interface to other components, including sensors 214, remediation systems 158, one or more cameras 160 and tow mode circuit 216 and remediation systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 214 can include, for example, sensors 52 such as those described above with reference to the example of FIG. 1. Sensors 214 can include additional sensors that may or not otherwise be included on a standard vehicle 10 with which the payload monitoring system 200 is implemented. For example, sensors 214 may include vehicle acceleration sensors, vehicle speed sensors, accelerometers such as a 3-axis accelerometer 222 to detect roll, pitch and yaw of the vehicle, and environmental sensors 228 (e.g., to detect salinity or other environmental conditions), among others. Additional sensors 232 can also be included as may be appropriate for a given implementation of payload monitoring system 200.

Remediation systems 158 can include any of a number of different components or subsystems used to control or adjust various aspects of the payload and its environment. In this example, the remediation systems 158 include a cooling system 278 to adjust the temperature of the payload downward (a heating system may also be included). Remediation systems 158 may also include an actuatable restraint system that may include electromechanically operable winches, straps and tie-downs; blocks or partitions; or other adjustable cargo restraints. Other remediation components may also be included depending on the cargo or vehicle and depending on the issues that might be likely to arise with a given payload in a given payload space.

During operation, payload control circuit 210 receives image data from one or more cameras 160. This can be received, for example, via communications interface 201 over a wired or wireless link. Payload control circuit 210 may also receive information from sensors 214, the data from which may provide additional information regarding the status of the cargo. Information from tow mode system 216 may be included and used to actuate/disable the cargo monitoring depending on whether the vehicle is towing a trailer.

Payload control circuit 210 may process the image and sensor data received from one or more cameras 160 and one or more sensors 214, respectively, to determine the status or condition of the cargo. As noted above, in some embodiments the image and other data may be sent to a processing location external to the vehicle (e.g., Cloud Server 290) for off-vehicle processing.

Where the system determines that a cargo issue has occurred, the system can send a command to remediation systems 158 to take corrective action on the cargo. For example, where image analysis indicates that fresh cargo such as produce is too dry, the system may activate a misting system 278 to spray moisture onto the cargo. As another example, where the payload monitoring circuit 200 determines that the cargo is not properly restrained, the system may send instructions to one or more actuatable components of restraint system 280 to secure the cargo. In some embodiments, the system may determine which particular portion or area of the cargo is not secured and actuate specific components of restraint system 280 to address only those portions or areas of the cargo in need of attention.

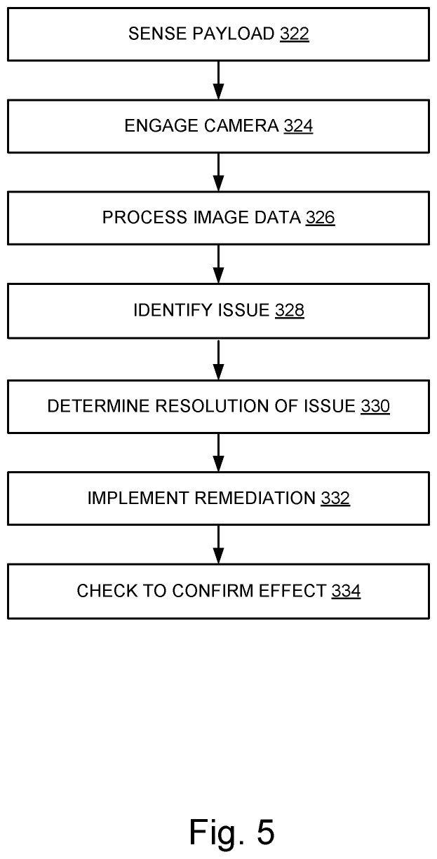

FIG. 5 illustrates an example process for cargo monitoring and remediation in accordance with one embodiment. Referring now to FIG. 5, at operation 322, the system may sense whether or not cargo is present in a cargo area of the vehicle. For example, sensors 214 may include weight sensors, infrared sensors or other sensors that can be used to detect the presence of cargo. Data from the sensors can be provided to a processing circuit such as, for example, payload control circuit 210, to determine whether cargo is present in the cargo area. Additionally, information from a tow mode circuit 216 may also be used to determine whether cargo is present in a cargo area of the vehicle. In further embodiments, the system may be manually enabled allowing an operator or other authorized user to activate the system when cargo is present such as by a user interface.

When the system determines that cargo is present or the system is otherwise activated, one or more cameras may be activated at operation 324. In some implementations, cameras may remain active at all times, while in other embodiments cameras are turned off or in a sleep mode until activated. Various other sensors used by the cargo monitoring system may likewise be activated, awakened or accessed at this time. When the system is activated, payload monitoring circuit 210 captures data from applicable cameras and other sensors.

At operation 326, the system processes the captured image and other sensor data (as applicable). The data analysis is performed to determine whether the cargo is in satisfactory condition, or whether there are any issues with the cargo that need to be addressed. This is indicated operation 328. In some embodiments, where there is an issue with the cargo, an alert can be generated indicating the existence of the issue and describing the issue with the cargo. The alert can be sent to the operator of the vehicle such as by and audible or visual alert, which may be provided through the vehicle head unit or otherwise through operator interfaces in the vehicle. An alert can also be sent to other systems or personnel remote from the vehicle such as, for example, to a vehicle dispatcher or operations control center.

At operation 330, the system determines corrective action to be taken to address the cargo issue. The corrective action may depend on the type and extent of the issue detected. In terms of examples described above, were the issue detected is that the cargo is improperly secured, the system may determine that the appropriate corrective action is to tighten the restraints used to restrain the cargo. The system may determine which restraints are most appropriate to adjust given the issues detected with the cargo. As a further example, where one end of the cargo appears to be bouncing unacceptably but the opposite end is behaving normally, the restraints at the end that is behaving unacceptably may be tightened.

Accordingly, at operation 332 the system implements the determined remediation. This may be implemented by generating and sending the appropriate correction signal (e.g, a control signal) to the appropriate actuators to adjust a payload characteristic to implement the desired action. For example, the system may send a control signal to one or more winches to tighten those winches to more securely contain the cargo. At operation 334, the system can continue to monitor the payload to confirm that the desired effect has been achieved and to continue to monitor for a recurrence or for other conditions.

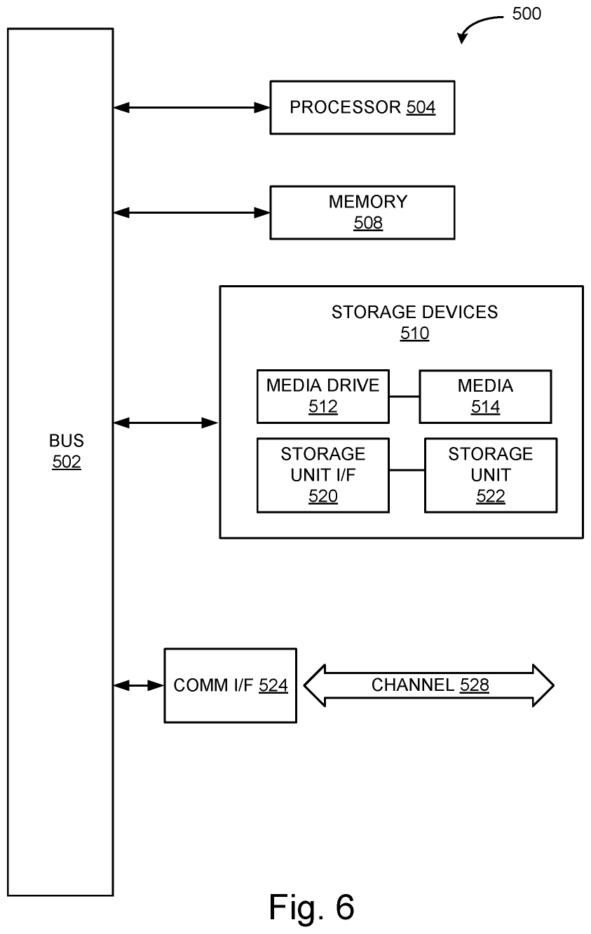

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 500. After reading this description, it will become apparent to a person skilled in the relevant art how to implement the application using other computing components or architectures.

Referring now to FIG. 6, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for automatically adjusting a vehicle payload, comprising:
an image sensor mounted to capture images of a vehicle payload;
a cargo monitoring circuit coupled to receive captured images of the vehicle payload from the image sensor and configured to process the received captured images to detect a payload characteristic;
a processing device configured to determine a payload status based on the payload characteristic and to generate a correction signal if the determined payload status indicates the payload is out of specification; and
an actuator coupled to receive the correction signal from the processing device, the actuator configured to perform an action to adjust a payload characteristic in response to the correction signal.

2. The system of claim 1, further comprising a motion sensor mounted to collect data regarding movement of the payload; wherein the processor is further configured to evaluate the data collected from the motion sensor to determine whether an amount of movement of the payload is above a determined threshold.

3. The system of claim 2, wherein the actuator comprises a cargo restraint device and wherein the action to adjust a payload characteristic performed by the actuator comprises adjusting the restraint device to tighten a restraint on the payload.

4. The system of claim 2, wherein the actuator comprises a water valve coupled to a nozzle and wherein the action to adjust a payload characteristic performed by the actuator comprises opening the water valve for a determined period of time to apply moisture to the payload.

5. The system of claim 1, wherein the processing device is further configured to determine which corrective action to implement to adjust the payload characteristic.

6. The system of claim 1, wherein the processing device is further configured to generate an alert indicating that the payload is out of specification.

7. The system of claim 1, wherein the processing device configured to determine a payload status based on the payload characteristic comprises a processing device located onboard the vehicle or remote to the vehicle.

8. A method for automatically adjusting a vehicle payload, comprising:
capturing images of a vehicle payload using an image sensor;
receiving the captured images of the vehicle payload from the image sensor and processing the received captured images to detect a payload characteristic;
determining a payload status based on the payload characteristic and generating a correction signal if the determined payload status indicates the payload is out of specification; and
transmitting the correction signal to an actuator configured to perform an action to adjust a payload characteristic in response to the correction signal.

9. The method of claim 8, further comprising collecting motion data regarding movement of the payload and evaluating the collected motion data to determine whether an amount of movement of the payload is above a determined threshold.

10. The method of claim 9, wherein the actuator comprises a cargo restraint device and wherein the action to adjust a payload characteristic performed by the actuator comprises adjusting the restraint device to tighten a restraint on the payload.

11. The method of claim 9, wherein the actuator comprises a water valve coupled to a nozzle and wherein the action to adjust a payload characteristic performed by the actuator comprises opening the water valve for a determined period of time to apply moisture to the payload.

12. The method of claim 8, wherein the method further comprises determining which corrective action to implement to adjust the payload characteristic.

13. The method of claim 8, further comprising generating an alert to an operator of the vehicle indicating that the payload is out of specification.

14. The method of claim 8, wherein the operation of determining a payload status based on the payload characteristic is performed onboard the vehicle or remote to the vehicle.

15. A vehicle payload system for automatically adjusting a vehicle payload, comprising:
a processor; and
a memory coupled to the processor to store instructions, which when executed by the processor, cause the processor to perform operations, the operations comprising
receiving captured images of a vehicle payload from an image sensor mounted on the vehicle and processing the received captured images to detect a payload characteristic;
determining a payload status based on the payload characteristic and generating a correction signal if the determined payload status indicates the payload is out of specification; and
transmitting the correction signal to an actuator configured to perform an action to adjust a payload characteristic in response to the correction signal.

16. The payload system of claim 15, further comprising collecting motion data regarding movement of the payload and evaluating the collected motion data to determine whether an amount of movement of the payload is above a determined threshold.

17. The payload system of claim 16, wherein the actuator comprises a cargo restraint device and wherein the action to adjust a payload characteristic performed by the actuator comprises adjusting the restraint device to tighten a restraint on the payload.

18. The payload system of claim 16, wherein the actuator comprises a water valve coupled to a nozzle and wherein the action to adjust a payload characteristic performed by the actuator comprises opening the water valve for a determined period of time to apply moisture to the payload.

19. The payload system of claim 15, wherein the method further comprises determining which corrective action to implement to adjust the payload characteristic.

20. The payload system of claim 15, further comprising generating an alert to an operator of the vehicle indicating that the payload is out of specification.
